(19) United States
(12) Patent Application Publication
(10) Pub. No.: US 2009/0221727 A1
(43) Pub. Date: Sep. 3, 2009

(54) Composition and Process for Conversion of Paint Sludge Into Reusable Paint

(76) Inventors: Raj Kumar Bhatia, New Delhi (IN); Vipen Kumar Bhatia, New Delhi (IN); Anand Shanker Vishnoi, New Delhi (IN)

Correspondence Address: LADAS & PARRY LLP, 26 WEST 61ST STREET, NEW YORK, NY, 10023, US

(21) Appl. No.: 12/086,788

(22) PCT Filed: Dec. 18, 2006
(86) PCT No.: PCT/IN2006/000495

§ 371 Date: Oct. 6, 2008

(30) Foreign Application Priority Data
Dec. 19, 2005 (IN) 3394/DEL/2005

(51) Int. Cl. C08J 11/06

(52) U.S. Cl. 521/40.5; 521/48; 521/40

(57) ABSTRACT

The present invention relates to a composition for the conversion of paint sludge into reusable paint, to a process for the preparation of said composition and to a process for the conversion of waste paint sludge back to useful paint. The sludge conversion process of the invention consumes the environmentally hazardous sludge collected from paint application systems by converting this paint sludge into a reusable paint.

### FIELD OF THE INVENTION

The present invention relates to a composition for the conversion of paint sludge into reusable paint, to a process for the preparation of said composition and to a process for the conversion of waste paint sludge back to useful paint. The sludge conversion process of the invention consumes the environmentally hazardous sludge collected from paint application systems by converting this paint sludge into a reusable paint.

### BACKGROUND OF THE INVENTION

Most original equipment manufacturers (OEM's) use spray technique for painting their components. In this process the paint is mixed/thinned with appropriate thinner to get required application viscosity. Then it is applied by spray method on respective components in a paint booth. During spray method some paint adheres on the component being spray painted. Over-sprayed paint goes to water stream as a waste. This over sprayed waste paint gets mixed with water stream and gets coagulated by flocculent present in water stream. From this water stream the sludge is collected using the flotation method. Generally this sludge is either dumped or incinerated by industries, which is environmentally hazardous. Typically, the sludge obtained is either not biodegradable or degrades at a very slow rate. Therefore, dumping or earth filling of such sludge poses an environmental hazard. Burning of this sludge also produces toxic flames causing environment pollution. Therefore dumping, earth filling or burning of paint sludge is not an environmentally safe method for disposal. It is therefore important to devise a method by which paint sludge can be converted at least in part into reusable paint by separating the paint component of such sludge. This will assist in reducing the environmental hazards associated with the paint process.

To the best of the applicant's knowledge, no processes are known in the art for recovery of paint from paint sludge such that useful paint can be recycled and environmental concerns addressed at the same time.

### OBJECTS OF THE INVENTION

The main object of the invention is to provide a composition useful for the recovery of reusable paint from paint sludge.

It is another object of the invention to provide a process for the recovery of reusable paint from paint sludge, which is environmentally friendly and inexpensive.

### SUMMARY OF THE INVENTION

The above and other objects of the present invention are attained by the novel composition of this invention which comprises a mixture of solvents in specific amounts with or without resins and a process for the use thereof which enables conversion of paint sludge into reusable paint.

Accordingly, the present invention provides a process for conversion of the sludge into a usable paint form comprising

(a) subjecting wet paint sludge to a water rinse;
(b) chemically treating the water rinsed sludge obtained at the end of step (a);
(c) subjecting the chemically treated sludge to a further water treatment;
(d) treating the wet sludge obtained at the end of step (c) to rinsing with methyl alcohol;
(e) subjecting the rinsed sludge obtained at the end of step (d) to extraction to remove liquid content therefrom;
(f) drying the sludge obtained at the end of step (e);
(g) soaking the dried sludge in one or more solvents depending on the type of paint sludge taken as raw material, and stirring the soaked sludge to form a homogenous mixture;
(h) subjecting said homogeneous mixture to a first filtration to remove particles larger than +100 mesh therefrom;
(i) subjecting the filtrate obtained at the end of step (h) to pulverisation to further reduce the size of particles to +2 to +3 Hegman's Gauge fineness;
(j) subjecting the pulverised particles to a further filtration using 150-200 mesh to remove larger particles;
(k) adding one or more resins, and other conventional additives and pigments if desired, to the filtrate and grinding the mixture to a particle size of +6 Hegman's Gauge fineness;
(l) filtering the composition obtained at the end of step (k) to a particle size in the range of 300-400 mesh to obtain reusable paint.

In one embodiment of the invention, the chemical rinse is carried out using sodium sodium bicarbonate sol if the booth additive is acidic or PTSA if the booth additive is alkaline.

In another embodiment of the invention, the sodium bicarbonate sol is used in an amount of 3-10% by weight of the sludge.

In another embodiment of the invention, the paratoluene sulphonic acid is used in an amount of 0.2-0.5% by weight of the sludge.

In another embodiment of the invention, in step (e) liquid extraction is carried out using pressing or centrifugation or mild heating conditions.

In another embodiment of the invention, the pressed sludge is dried at a temperature in the range of 35-75° C. or dried for a period of 1-72 hours at ambient, depending on sludge condition and quality.

In another embodiment of the invention, the soaking is carried out for a period in the range of 1-48 hours.

In another embodiment of the invention, the stirring is carried out for a period in the range of 0.5-4 hours.

In another embodiment of the invention, particles larger than 100 mesh are recycled back for reduction in size by any conventional pasting or pulverising means.

In another embodiment of the invention, pulverisation is effected using a ball mill, an attritor mill or any other conventional mill.

In another embodiment of the invention, particles larger than 150-200 mesh removed at the end of step (j) is recycled back for pulverisation to further reduce the size thereof.

In another embodiment of the invention, the solvent is selected from the group consisting of toluene, orthoxylene, renine, C-9/GR-150 solvents, paraxylene, n-butanol, methanol, isopropyl alcohol, diacetone alcohol, isobutyl alcohol, mosstanol, butyl acetate, ethyl acetate, cellosolve acetate, butyl cellosolve, ethyl cellosolve, methyl isobutyl ketone, cyclohexanol, methyl ethyl ketone, dipentene, xylene mixture, butyl carbitol, or any mixture thereof.

In another embodiment of the invention, the paint sludge is selected from the group consisting of amino alkyd based paint sludge, epoxy paint sludge, acrylic based paint sludge, polyester melamine based paint sludge, aminopolyester paint based sludge, thermosetting acrylic sludge, urea based sludge, silicone or modified silicone based paint sludge and acrylated alkyd paint sludge or any mixture thereof.

In another embodiment of the invention, the resin is selected from the group consisting of amino alkyd, aminopolyesters or amino fatty acid akyds, thermosetting acrylic, acrylic and melamine (amino acrylics), modified epoxys, epoxyesters, acrylated alkyd, thermoplastic acrylic, silicone or modified silicone, urea formaldehyde, petrase resin, nitrocellulose, melamine formaldehyde.

In another embodiment of the invention, the conventional additives are selected from the group consisting of anti-setting agents, anti-corrosion additives, thickening agents, dispersing agents, anti-oxidants, plasticizers, bonding agents, gloss improvers, drying agents and any other conventional property enhancing additives.

In another embodiment of the invention, the anti-setting agent is selected from Antil 312, manufactured by K Tech India Pvt. Ltd., the anti-corrosion agent is selected from K Cor-463 manufactured by K Tech India Pvt. Ltd., the dispersing agent is selected from soyalecithin, the antioxidant is selected from K-Anox 1001 or equivalents thereof manufactured by K Tech India Pvt. Ltd., the plasticising agent is selected from dibutyl phthalate, the drying agent is selected from metallic octates and metallic naphthanates, and the bonding agent is selected from calcium octate, cobalt octate, manganese octate and the like.

In another embodiment of the invention, the pigment is selected from the group consisting of china clay, barites, calcite, zinc oxide, zinc chromate, talc, silicon powder (micropulverised), titanium dioxide, carbon black or any other conventional pigments or conventional coloring agent.

In another embodiment of the invention, the thickening agent is selected from the group consisting of benton gel, tixo gels or any other thixotropic agent.

### DETAILED DESCRIPTION OF THE INVENTION

Paint generally comprises of the following materials:

### 1. Resin

### 2. Pigment and Extenders

### 3. Solvents

### 4. Additives

All the ingredients are present in a homogeneous dispersed state. All have their specific roles in paint properties. Over-sprayed paint material consists of all the ingredients but very small percentage of solvents. When it is mixed in water and flocculates, solvent content is reduced further and the paint residuals become small droplets. The coagulation of small droplets results in mass formation i.e. sludge.

Several different types of sludge are generated in the paint industry. Some of the paint systems where the process of the invention can be used are Epoxy-amino/phenolic system (Single Pack—Stoving System), Alkyd-amino system, Thermosetting acrylic systems, Thermoplastic-acrylic system. Depending on the type of sludge, the resins used can be any one or combination of the following:

(a) amino-alkyd
(b) amino polyester or amino antacid alkyd
(c) thermosetting acrylic
(d) acrylic and melamine mix (amino acrylic)
(e) modified epoxy
(f) epoxy and epoxyesters
(g) acrylated alkyd
(h) thermoplastic acrylic
(i) silicone or modified silicone based paint sludge
(j) urea formaldehyde

The process for conversion of the sludge into a usable paint form according to the present invention comprises subjecting wet paint sludge to a water rinse followed by a chemical rinse. During the chemical rinse, depending on the nature of the booth additive, the chemical used for treatment can be sodium bicarbonate sol (if the booth additive is acidic) or by PTSA (if the booth additive is alkaline). The sodium bicarbonate sol is preferably used in an amount of 30.5-15% by weight of the sludge and the PTSA when used is used in an amount of 0.1-15% by weight.

The chemically treated wet paint sludge is then rinsed with water or demineralised water and then rinsed again in methyl alcohol or ethyl alcohol depending on the type of sludge. The sludge is then pressed or centrifuged in order to remove the liquid content. Any other method of liquid extraction such as mild heating can also be carried out. After extraction of liquid, the sludge is dried in a thermostatically controlled hot air oven at a temperature in the range of 35-75° C. depending or for a period of 2-72 hours at ambient (depending on sludge quality). The dried sludge is then charged to a soaking bin and a combination of solvent mix is added therein and the mixture is allowed to soak for a period in the range of 1-72 hours depending on sludge composition or condition. The soaked sludge is then stirred to form a homogenous mixture. Stirring again depends on sludge condition and is generally required to be carried out for a period in the range of 0.5 to 8 hours. The stirred sludge is then sieved/filtered through a 100 mesh filter to eliminate large agglomerated particles. The filtered out particles can be recycled to be reduced in size by any convention pasting means. The filtrate is then charged into a mill such as a attrition mill, a ball mill or any other conventional mill and then pulverised to a particle size in the range of +2 to +3 Hegman's Gauge. The pulverised sludge particles are then filtered through a 150-200 mesh filter to remove larger particles, which can then be recycled to the step of pulverisation. A resin or combination of resins are then added to the filtrate along with desired additives and pigments and the mixture again milled to +6 Hegman's Gauge fineness. The mill is an attrition mill, a ball mill or any other conventional mill. The pulverised product thus obtained is then passed through a 300-400 mesh filter and manually filtered or filtered through any automated filtering means to obtain reusable paint.

Contaminants are removed prior to treatment. The sludge obtained from a booth is a semisolid mass containing paint residuals, water, oil/greases along with flocculent (Booth Additive). Water, Oil/grease and Flocculent has detrimental effect on paint properties and its reusability. These contaminants are either have to be eliminated or prevented from coming into the process. Flocculent having acidic properties will damage the paint by creating problems. To avoid this problem, the additive to be used should have alkaline nature instead of acidic. Oil/Grease contamination into the sludge should be avoided during the sludge formation and collection process. Water also to be removed from the sludge, which will be discussed in the process itself.

The present invention uses several additives individually or in combination for use in the conversion of paint sludge of the above categories into reusable paint. The choice of additive would depend on the type of paint sludge though some additives can be used with different types of paint sludge. The additives used herein include anti-setting additives such as Antil-310, NILSET-117 or soya lecithin. Other additives that are used include WD-1020 or WD-1040 or RHNOL-G-101 or BYK-410 for use as dispersing agents. Anticorrosive additives include K-Cor 463 or other commercially available anti-corrosive agents. Plasticizing agents can be used depending on the type of paint sludge and include DOP-DVP. Metallic octates or metallic naphthanates can also be used as drying agents for unibake or QD based primers. Bonding agents such as PA-51 can also be used as additives.

During the conversion process, several pigments can be added to achieve the desired colour paint. For example, china clay, barite, calcite, zinc oxide, zinc chromate, talc, sodium (powder), titanium dioxide, carbon black or any other conventional pigments can be added. During the conversion process, thickening agent such as benton gel, tixo gels or any other thixotropic agent can also be added.

It is an important feature of the invention that the resin used can be a single resin or a combination of resins.

The invention will now be described with reference to the following examples. Some of the paint systems where the process of the invention can be used are Epoxy-amino/phenolic system (Single Pack—Stoving System), Alkyd-amino system, Thermosetting acrylic systems, Thermoplastic-acrylic system. In all the following examples, the process defined above was followed.

### Example-1

| Name of Chemicals | Range of Chemicals |
|---|---|
| Sludge | 48.58% |
| IRL-294-(Epoxy Ester) | 10.0-5% |
| P-101 (Epoxy Resin-Lapox) | 3.0-5.0% |
| Chine Clay | 7.0-12.0% |
| Zinc Chrome | 4.0-9.0% |
| Zinc Phosphate | 1.0-4.0% |
| Carbon Black | 0.1-0.5% |
| Soya lecithin (Additive) | 0.0-0.5% |
| Thixo Gel (Additive-BYK-Chemic) | 0.2-2.0% |
| 6018 (Additive-Dow Corning) | 0.3-0.6% |
| Co octate (Dryer) | 0.2-0.7% |
| K-Cor 463 (Additive-K. Tech.) | 0.3-0.6% |
| Urea Formaldehyde-5813 (Resin) | 0.5-1.2% |
| R-717 (Melamine Resin) | 1.5-5.0% |
| Lead Octate (Dryer-R. K. Metchem) | 0.1-0.5% |
| Ca Octate (Dryer) | 0.1-0.5% |

Solvent Combinations:

| | |
|---|---|
| C-9 Solvent | 5.0-7.5% |
| Xylene | 20.0-40.0% |
| ISO Butyl Alcohol | 0-15.0% |

### Example-2

### Structural Primer

| Name of Chemicals | Range of Chemicals |
|---|---|
| Sludge | Rest |
| Soyalecithin | 0.3-0.8% |
| P-101 (Epoxy Resin-Lapox) | 3.0-9.0% |
| Petry's Resin | 0.7-3.5% |
| Dipentene (Modifying Solvent) | 1.0-3.0% |

### Example-3

| Name of Chemicals | Range of Chemicals |
|---|---|
| Sludge | 58-78% |
| Soya lecithin | 0.3-0.8% |
| Carbon Black | 0.0-0.3% |
| Bentone Gel | 0.9-3.5% |
| IRL-294 (Epoxy Ester-Resin) | 5.0-9.5% |
| R-584 (Alkyd Resin) | 4.0-8.0% |
| China Clay | 3.5-8.2% |
| Zinc phosphate | 5.0-7.5% |
| BYK-410 | 0.0-0.4% |
| K Cor-463 (Anti Corrosion Additive) | 0.0-0.4% |
| Manganese Octate (Dryer) | 0.2-2.0% |
| Cobalt Octate (Dryer) | 0.1-2.0% |
| MF-5802 (Melamine Resin) | 0.9-1.8% |
| DBP (Plasticizer) | 0.1-2.0% |
| Urea formaldehyde-5813(Resin) | 0.5-1.5% |
| Calcium Octate (Dryer) | 0.5-1.2% |
| Zinc Oxide | 2.3-6.5% |

Solvent Combinations:

| | |
|---|---|
| Xylene | 75.0-90.% |
| Butyl Cello Solve | 2.0-15.0% |
| Methyl isobutyl Ketone | 2.0-10.0% |

### Example-4

| Name of Chemicals | Range of Chemicals |
|---|---|
| Thinner | 41.0-55% |
| IRL-294 (Epoxy Ester-Resin) | 4.5-7.5% |
| Id ester-1004 (Polyester Resin) | 5.5-8.0% |
| R-581 (Alkyd-Resin) | 3.0-5.0% |
| R-5452(Epoxy Resin-RPL) | 3.0-5.5% |
| China Clay | 11.0-13.0% |
| Zinc Chrome | 5.5-7.5% |
| Zinc Phosphate | 6.0-8.0% |
| Cobalt Octate (Dryer) | 0.1-0.3% |
| Manganese Octate (Dryer) | 0.05-2.5% |
| Calcium Octate (Dryer) | 0.05-2.5% |

### Example-5

| Name of Chemicals | Range of Chemicals |
|---|---|
| Sludge | 55.0-65.0% |
| R-581(Alkyd Resin) | 5.0-8.0% |
| P-101 (Melamine Resin) | 5.0-8.0% |
| China Clay | 10.0-14.0% |
| Bentone Gel | 2.0-5.0% |
| Soya lecithin | 0.2-0.6% |
| K. Cor-463 (Additive) | 0.5-1.0% |
| Manganese Octate (Dryer) | 0.5-1.0% |
| Cobalt Octate (Dryer) | 0.5-1.0% |
| BYK-410 (Additive) | 0.05-1.0% |
| DBP-(Plastisizer) | 0.5-2.5% |
| Zinc Oxide | 3.0-6.0% |
| Zinc Phosphate | 0.5-2.5% |
| PA-51 (10% SOL) | 0.5-2.5% |
| (Antifloating Agent) | |

Solvent Combination:

| | |
|---|---|
| Methyl ISO Butyl Ketone | 0.0-10.0% |
| Butyl Cello Solve | 2.0-9.0% |
| Xylene | Rest |

### Example-6

| Name of chemicals | Range of Chemicals |
|---|---|
| Sludge | 40.0-50.0% |
| R-926 (Thermosetting Acrylic-Resin) | 22.0-32.0% |
| R-5804 (Melamine Resin) | 12.0-19.0% |
| Tixo Gel (Antifloating Agent) | 0.9-1.8% |
| TiO₂ (Titanium Dioxide) | 2.0-5.0% |
| Zinc Phosphate | 2.0-3.5% |
| Zinc Chrome | 0.2-3.5% |
| China Clay | 4.0-8.0% |
| Carbon Black | 1.0-2.5% |
| Soya lecithin | 0.05-0.35% |
| K. Cor-463 | 0.08-0.28% |

Solvent Combinations:

| | |
|---|---|
| Di Acetone Alcohol | 25.0 30.0% |
| C-9 | 20.0-30.0% |
| Methyl ISO Butyl Ketone | 2.0-10.0% |
| Butyl Cello Solve | 2.0-7.0% |
| Butyl Carbitol | Rest (Alternate) |

### Example-7

| Name of Chemicals | Range of Chemicals |
|---|---|
| Sludge | 4.0-5.5% |
| R-926 (Thermosetting Acrylic) | 33.0-42.0% |
| R-5804 (Melamine-Resin 0 | 11.0-15.0% |
| Titanium Di-oxide | 2.0-0.5% |
| Carbon Black | 1.0-2.5% |
| Soya lecithin | 0.1-0.5% |
| Zinc Phosphate | 1.5-4.5% |
| BYK-410 (Additive) | 0.05-0.25% |

Solvent Combinations:

| | |
|---|---|
| Diacetone Alcohol | 15.0-25.0% |
| Butyl Carbitol | 25.0-45.0% |
| Cyclohexanol | 0-15.0% |

### Example-8

| Name of chemicals | Range of Chemicals |
|---|---|
| 75% Chassis sludge | 55.0-65.0% |
| 25% Sheet metal sludge | |
| Sludge | |
| R-581 (thermosetting Acrylic-Resin) | 4.0-8.0% |
| R-5452 | 4.0-8.0% |
| China Clay | 10.0-18.0% |
| Butone Gel | 2.0-5.0% |
| Soya lecithin | 1.0-2.5% |
| K. Cor-463 | 0.5-2.5% |
| Manganese octate | 0.5-1.5% |
| Cobalt Octate | 0.0-1.5% |
| Lead Octate | 0.2-1.2% |
| Calcium Octate | 0.05-2.0% |
| BYK-410 | 0.05-0.20% |
| Zinc Oxide | 1.0-4.0% |
| Zinc Phosphate | 0.5-3.5% |
| Urea formaldehyde-5813(Resin) | 1.5-4.5% |
| DBP (Plasticizer) | 1.5-4.5% |
| Anchor-205-(20 sol.) | 3.0-8.0% |

Solvent Combination:

| | |
|---|---|
| Xylene | 70.0 90.0% |
| Butyl Cello Solve | 5.0-15.0% |
| Methyl ISO Butyl ketone | 2.0-8.0% |
| Cello solve Acetate | 2.0-8.0% |

The above examples are illustrative of the invention. It will be evident to a person of skill in the art that variations and modifications are possible without departing from the spirit and scope of the invention.

1. A process for conversion of sludge into a usable paint form comprising the steps of:
(a) subjecting wet paint sludge to a water rinse;
(b) chemically treating the water rinsed sludge obtained from step (a);
(c) subjecting the chemically treated sludge of step (b) to a further water treatment;
(d) treating the wet sludge obtained at the end of step (c) to rinsing with methyl alcohol;
(e) subjecting the rinsed sludge of step (d) to extraction to remove liquid content therefrom;
(f) drying the sludge obtained from step (e);
(g) soaking the dried sludge in one or more solvents and stirring the soaked sludge to form a homogenous mixture;
(h) subjecting said homogeneous mixture of step (g) to a first filtration to remove particles larger than +100 mesh therefrom;
(i) subjecting the filtrate obtained in step (h) to pulverisation to further reduce the size of particles to +2 to +3 Hegman's Gauge fineness;
(j) subjecting the pulverised particles to a further filtration using 150-200 mesh to remove larger particles;
(k) adding one or more resins, and other additives and pigments as desired, to the filtrate and grinding the mixture to a particle size of +3 to +6 Hegman's Gauge fineness; and
(l) filtering the composition in obtained at the end of step (k) to a particle size in the range of +5 Hegman Gauge to +8 Hegman Gauge, by filtering it, through a filter of 300-500 mesh to obtain reusable paint.

2. The process as claimed in claim 1, wherein the chemical rinse is carried out using a weak alkali solution if a booth additive is acidic, or an acid solution if a booth additive is alkaline.

3. The process as claimed in claim 2, wherein the weak alkaline solution is used in an amount of 3-10% by weight of the sludge.

4. The process as claimed in claim 2, wherein the acid solution is used in an amount of 0.1-1.5% by weight of the sludge.

5. The process as claimed in claim 1, wherein in step (e) liquid extraction is carried out using pressing, centrifugation or mild heating conditions.

6. The process as claimed in claim 5, wherein the pressed sludge is dried at a temperature in the range of 35-75° C. for a time period of 4 to 24 hours.

7. The process as claimed in claim 1, wherein the soaking is carried out for a time period of 1-48 hours, the stirring is carried out for a time period of 0.5-2 hours.

8. The process as claimed in claim 1, wherein particles larger than 100 mesh are recycled back for reduction in size by pasting or pulverising means.

9. The process as claimed in claim 1, wherein pulverisation is effected using a ball mill, an attritor mill or any other mill.

10. The process as claimed in claim 1, wherein the particles larger than 150-200 mesh removed at the end of step (j) are recycled back for pulverisation to further reduce the size thereof.

11. The process as claimed in claim 1, wherein the solvent is selected from the group consisting of toluene, orthoxylene, renine, C-9/GR-150, parazylene, n-butanol, methanol, isopropyl alcohol, diacetone alcohol, isobutyl alcohol, mosstanol, butyl acetate, ethyl acetate, cellosolve acetate, butyl cellosolve, ethyl cellosolve, methyl isobutyl ketone, cyclohexanol, methyl ethyl ketone, dipentene, and xylene mixture or a mixture thereof.

12. The process as claimed in claim 1, wherein the paint sludge is selected from the group consisting of amino alkyd based paint sludge, epoxy paint sludge, acrylic based paint sludge, polyester melamine based paint sludge, aminopoly ester paint based sludge, thermosetting acrylic sludge, urea based sludge, silicone or modified silicone based paint sludge and acrylated alkyd paint sludge.

13. The process as claimed in claim 1, wherein the resin is selected from the group consisting of methyl formamide, epoxyester resin, epoxy resin, polyester resin, petrase resin, alkyd resins, melamine resin, acrylic resin, and amino-alkyd resins or a mixture thereof.

14. The process as claimed in claim 1, wherein the conventional additives are selected from the group consisting of anti-setting agents, anti-corrosion additives, thickening agents, dispersing agents, anti-oxidants, plasticizers, bonding agents and drying agents.

15. The process as claimed in claim 14, wherein the anti-setting agent is Antil 312.

16. The process as claimed in claim 14, wherein the anti-corrosion agent is K-Cor 463.

17. The process as claimed in claim 14, wherein dispersing agent is soyalecithin.

18. The process as claimed in claim 14, wherein antioxidant is K-Anox 1001.

19. The process as claimed in claim 14, wherein plasticising agent is dibutyl phthalate.

20. The process as claimed in claim 14, wherein drying agent is selected from metallic octates and metallic naphthanates.

21. The process as claimed in claim 14, wherein bonding agent is Z-6018.

22. The process as claimed in claim 1, wherein the pigment is selected from the group consisting of china clay, barite, calcite, zinc oxide, zinc chromate, talc, silicon powder, titanium dioxide, carbon black or any other conventional pigments.

23. The process as claimed in claim 1, wherein the thickening agent is selected from the group consisting of benton gel, tixo gels or any other thixotropic agent.

24. The method according to claim 2, wherein the weak alkali solution is sodium bicarbonate.

25. The method according to claim 2, wherein the acid solution is PTSA.

26. The method according to claim 6, wherein the pressed sludge is dried at ambient temperature.
